(19) United States
(12) Patent Application Publication
(10) Pub. No.: US 2023/0076931 A1
(43) Pub. Date: Mar. 9, 2023

(54) MULTIPLIER FOR FLOATING-POINT OPERATION, METHOD, INTEGRATED CIRCUIT CHIP, AND CALCULATION DEVICE

(71) Applicant: Anhui Cambricon Information Technology Co., Ltd., Hefei (CN)

(72) Inventors: Yao ZHANG, Hefei (CN); Shaoli LIU, Hefei (CN)

(21) Appl. No.: 17/620,601

(22) PCT Filed: Oct. 13, 2020
(86) PCT No.: PCT/CN2020/120717

§ 371 Date: Sep. 30, 2022

(30) Foreign Application Priority Data
Oct. 14, 2019 (CN) 201910970802.8
Oct. 9, 2020 (CN) 202011075144.5

(51) Int. Cl. G06F 7/499

(52) U.S. Cl. CPC G06F 7/49915; G06F 7/49957

(57) ABSTRACT

The present disclosure relates to a multiplier, a method, an integrated circuit chip, and a computation apparatus for a floating-point computation. The computation apparatus may be included in a combined processing apparatus, which may also include a general interconnection interface and other processing apparatus. The computation apparatus interacts with other processing apparatus to jointly complete computation operations specified by the user. The combined processing apparatus may also include a storage apparatus, which is respectively connected to the computation apparatus and other processing apparatus and is used for storing data of the computation apparatus and other processing apparatus. Solutions of the present disclosure may be widely used in various floating-point data computations

### CROSS REFERENCE OF RELATED APPLICATION

The present application claims priority to: Chinese Patent Application No. 201910970802.8 with the title of “MULTIPLIER FOR FLOATING-POINT OPERATION, METHOD, INTEGRATED CIRCUIT CHIP, AND CALCULATION DEVICE” filed on Oct. 14, 2019, and the present application claims priority to: Chinese Patent Application No. 202011075144.5 with the title of “MULTIPLIER FOR FLOATING-POINT OPERATION, METHOD, INTEGRATED CIRCUIT CHIP, AND CALCULATION DEVICE” filed on Oct. 9, 2020. The contents of the aforementioned applications are herein incorporated by reference in their entireties.

### TECHNICAL FIELD

The present disclosure generally relates to a floating-point computation field. More specifically, the present disclosure relates to a method, a multiplier, an integrated circuit chip and a computation apparatus for a floating-point computation.

### BACKGROUND

Among all kinds of sign processing algorithms at present, such as an inner product operation between vectors and a convolutional computation of a matrix, lots of multiplication and addition operations are involved, and efficiency of these multiplication and addition operations often depends on an execution speed of a multiplier. Even though execution efficiency of a multiplier has been remarkably improved at present, there is still room for improvement in processing floating-point-type data. Therefore, how to obtain a multiplier with high efficiency, low power consumption and a low cost to execute a multiplication operation of the floating-point-type data is a problem to be solved in the prior art.

### SUMMARY

To at least partly solve a technical problem mentioned in the background, solutions of the present disclosure provide a multiplier, a method, an integrated circuit chip including the multiplier, and a computation apparatus for a floating-point computation.

A first aspect of the present disclosure provides a multiplier configured to execute a multiplication computation of floating-point numbers according to a computation mode. The floating-point number at least comprises an exponent and a mantissa, and the multiplier comprises: an exponent processing unit configured to obtain an exponent after the multiplication computation according to the computation mode, an exponent of a first floating-point number and an exponent of a second floating-point number; and a mantissa processing unit configured to obtain a mantissa after the multiplication computation according to the computation mode, a mantissa of the first floating-point number and a mantissa of the second floating-point number. The computation mode is configured to indicate a data format of the first floating-point number and a data format of the second floating-point number.

A second aspect of the present disclosure provides a method for executing a floating-point number multiplication computation by using a multiplier. The floating-point number at least comprises an exponent and a mantissa, and the multiplier executes the multiplication computation based on a computation mode. The method comprises: using an exponent processing unit of the multiplier to obtain an exponent after the multiplication computation according to the computation mode, an exponent of a first floating-point number and an exponent of a second floating-point number; and using a mantissa processing unit of the multiplier to obtain a mantissa after the multiplication computation according to the computation mode, a mantissa of the first floating-point number and a mantissa of the second floating-point number. The computation mode is configured to indicate a data format of the first floating-point number and a data format of the second floating-point number.

A third aspect of the present disclosure provides an integrated circuit chip comprising the multiplier. In one or more embodiments, the multiplier of the present disclosure may form an independent integrated circuit chip or may be arranged in an integrated circuit chip or a computation apparatus to execute a computation of a floating-point number with various types of data formats.

By using the multiplier, a corresponding computation method, the integrated circuit chip and the computation apparatus, a computation of data with various floating-point types may be supported, and it is not required to provide a plurality of separate multipliers for data with different floating-point types. Therefore, the application of the multiplier of the present disclosure is flexible, and the multiplier of the present disclosure may be widely used in various floating-point data computations. In addition, when processing input data with a large bit width, the multiplier of the present disclosure supports a cyclical reusing operation, so that it is not required to arrange more processing chips, thereby reducing an arrangement area of an integrated circuit.

### BRIEF DESCRIPTION OF THE DRAWINGS

By reading the following detailed description with reference to the drawings, the above-mentioned and other objects, features and technical effects of the exemplary embodiments of the present disclosure may become easier to understand. In the drawings, several embodiments of the present disclosure are shown in an exemplary but not restrictive manner, and the same or corresponding reference numerals indicate the same or corresponding parts of the embodiments.

FIG. 1 is a schematic diagram of a floating-point data format, according to an embodiment of the present disclosure;

FIG. 2 is an schematic structural block diagram of a multiplier, according to an embodiment of the present disclosure;

FIG. 3 is a structural block diagram of more details of a multiplier, according to an embodiment of the present disclosure;

FIG. 4 is an schematic block diagram of a mantissa processing unit, according to an embodiment of the present disclosure;

FIG. 5 is a schematic diagram of a partial product operation, according to an embodiment of the present disclosure;

FIG. 6 is a schematic block diagram and an operation process of a Wallace tree compressor, according to an embodiment of the present disclosure;

FIG. 7 is an entire schematic block diagram of a multiplier, according to an embodiment of the present disclosure;

FIG. 8 is a flowchart of a method of performing a floating-point number multiplication computation by using a multiplier, according to an embodiment of the present disclosure;

FIG. 9 is a structural diagram of a combined processing unit, according to an embodiment of the present disclosure; and

FIG. 10 is a structural diagram of a board card, according to an embodiment of the present disclosure.

### DETAILED DESCRIPTION OF THE EMBODIMENTS

Technical solutions of the present disclosure provides a multiplier, a method, an integrated circuit chip, and a computation apparatus for a floating-point number computation. Different from a multiplier for a floating-point computation in the prior art, the present disclosure provides a multiplier that supports a plurality of types of computation modes, thus overcoming a defect that an existing multiplier only supports one type of floating-point computation. Specifically, the present disclosure uses the plurality of types of computation modes to indicate different types of floating-point data. In the multiplication computation process of the floating-point number, all types of operations of data may be executed based on one of the computation modes including operations such as encoding, compression, summation, normalization and rounding, thus implementing an operation associated with one of the plurality of types of floating-point data. Therefore, the multiplier of the present disclosure may support an operations in multi-mode, thereby improving flexibility of the floating-point computation and reducing costs of the floating-point computation.

The technical solutions and a plurality of embodiments of the present disclosure may be described in detail below with reference to drawings. It should be understood that many specific details of the floating-point computation will be described to provide a thorough understanding of the plurality of embodiments of the present disclosure. However, under the teaching of the present disclosure, those of ordinary skill in the art may practice the plurality of embodiments of the present disclosure without these specific details. In other cases, the content of the present disclosure does not describe well-known methods, processes, and components in detail, so as to avoid unnecessarily obscuration of the embodiments of the present disclosure. In addition, the description should not be regarded as a limitation on the scope of the plurality of embodiments of the present disclosure.

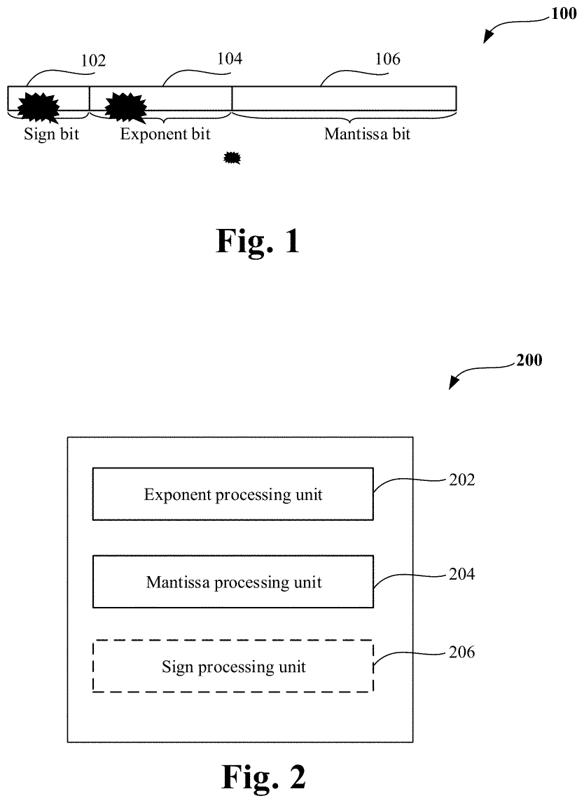

FIG. 1 is a schematic diagram of a floating-point data format 100, according to an embodiment of the present disclosure. As shown in FIG. 1, a floating-point number that may be applied to technical solutions of the present disclosure may include three parts, such as a sign (or a sign bit) 102, an exponent (or an exponent bit) 104 and a mantissa (or a mantissa bit) 106, where for an unsigned floating-point number, there may be no sign or sign bit. In some embodiments, the floating-point number that may be applied to the multiplier of the present disclosure may include at least one of numbers including a half-precision floating-point number, a single precision floating-point number, a brain floating-point number, a double precision floating-point number and a self definition floating-point number. Specifically, in some embodiments, a floating-point data format that may be applied to the technical solutions of the present disclosure may be a floating-point format that complies with an IEEE754 standard, such as a double precision floating-point number float64 (abbreviated as “FP64”), a single precision floating-point number float32 (abbreviated as “FP32”), or a half-precision floating-point number float16 (abbreviated as “FP16”). In some other embodiments, the floating-point data format may be an existing 16-bit brain floating-point number bfloat16 (abbreviated as “BF16”), or may be a self definition floating-point data format such as an 8-bit brain floating-point number bfloat8 (abbreviated as “BF8”), an unsigned half-precision floating-point number float16 (abbreviated as “UFP16”), or an unsigned 16-bit brain floating-point number bfloat16 (abbreviated as “UBF16”). In order to facilitate understanding, a following Table 1 shows part of the above-mentioned data format, where a sign bit width, an exponent bit width and a mantissa bit width are only used for an exemplary description.

TABLE 1

| Data | Sign bit | Exponent bit | Mantissa bit |
|---|---|---|---|
| type | width | width | width |
| FP16 | 1 | 5 | 10 |
| BF16 | 1 | 8 | 7 |
| FP32 | 1 | 8 | 23 |
| BF8 | 1 | 5 | 3 |
| UFP16 | 0 | 5(or6) | 11(or 10) |
| UBF16 | 0 | 8 | 8 |

For all types of the above-mentioned floating-point data formats, the multiplier of the present disclosure may at least support a multiplication operation of two floating-point numbers with any of the above formats, where the two floating-point numbers may have a same floating-point data format or different floating-point data formats. For example, the multiplication operation of two floating-point numbers may be an FP16*FP16, a BF16*BF16, an FP32*FP32, an FP32*BF16, an FP16*BF16, an FP32*FP16, a BF8*BF16, an UBF16*UFP16 or an UBF16*FP16.

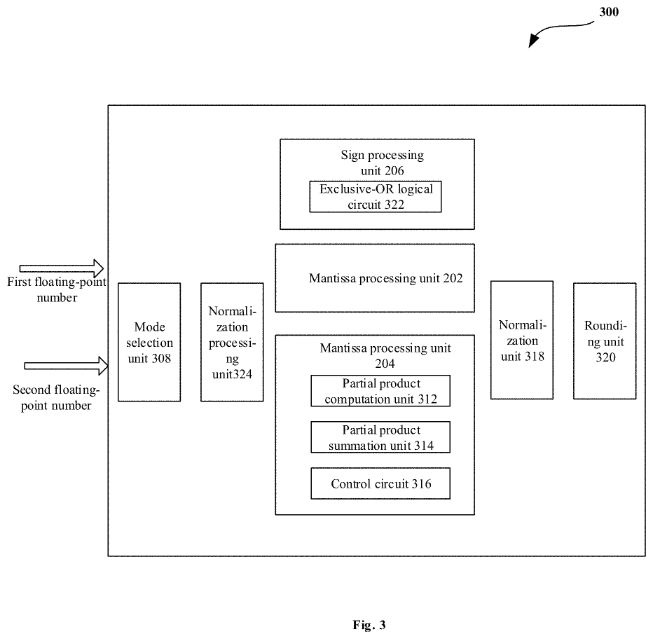

FIG. 2 shows a schematic structural block diagram of a multiplier 200, according to an embodiment of the present disclosure. As mentioned before, the multiplier of the present disclosure supports a multiplication operation of floating-point numbers with various types of data formats. These types of data formats may be indicated by using computation modes of the present disclosure, so as to make the multiplier work in one of a plurality of types of computation modes.

As shown in FIG. 2, the multiplier of the present disclosure may generally include an exponent processing unit 202 and a mantissa processing unit 204, where the exponent processing unit is configured to process an exponent bit of a floating-point number, and the mantissa processing unit is configured to process a mantissa bit of the floating-point number. Optionally or additionally, in some embodiments, if the floating-point number processed by the multiplier has a sign bit, the multiplier may further include a sign processing unit 206 configured to process a floating-point number including the sign bit.

In operations, the multiplier may execute the floating-point computation to a first floating-point number and a second floating-point number that are received, input or cached according to one of the computation modes, where the first floating-point number and the second floating-point number have one of the above-mentioned floating-point data formats. For example, when in a first computation mode, the multiplier may support the multiplication of two floating-point numbers FP16*FP16, and when in a second computation mode, the multiplier may support the multiplication of two floating-point numbers BF16*BF16. Similarly, when in a third computation mode, the multiplier may support the multiplication of two floating-point numbers FP32*FP32, and when in a fourth computation mode, the multiplier may support the multiplication of two floating-point numbers FP32*BF16. The correspondence of exemplary computation modes and floating-point numbers is shown in Table 2 below.

TABLE 2

| Computation | Computation floating-point |
|---|---|
| mode number | number type |
| 1 | FP16*FP16 |
| 2 | BF16*BF16 |
| 3 | FP32*FP32 |
| 4 | FP32*BF16 |

In an embodiment, the above-mentioned Table 2 may be stored in one memory of the multiplier, and the multiplier selects one of the computation modes in the Table according to an instruction received from an external device. For example, the external device may be an external device 1012 shown in FIG. 10. In another embodiment, an input of the computation mode may be automatically implemented through a mode selection unit 308 shown in FIG. 3. For example, when two FP16-type floating-point numbers are input into the multiplier of the present disclosure, the mode selection unit may select the multiplier to be operated in the first computation mode according to the data formats of the two floating-point numbers. For another example, when a FP32-type floating-point number and a BF16-type floating-point number are input into the multiplier of the present disclosure, the mode selection unit may select the multiplier to be operated in the forth computation mode according to the data formats of the two floating-point numbers.

It may be seen that different computation modes of the present disclosure are associated with corresponding floating-point data. In other words, the computation mode of the present disclosure may be configured to indicate the data format of the first floating-point number and the data format of the second floating-point number. In another embodiment, the computation mode of the present disclosure may not only be configured to indicate the data format of the first floating-point number and the data format of the second floating-point number, but may also be configured to indicate a data format after the multiplication computation. With reference to Table 2, the extended computation modes are shown in the following Table 3.

TABLE 3

| | Computation | |
|---|---|---|
| Computation | floating-point | Output |
| mode number | number type | result type |
| 11 | FP16*FP16 | FP16 |
| 12 | | BF16 |
| 13 | | FP32 |
| 21 | BF16*BF16 | FP16 |
| 22 | | BF16 |
| 23 | | FP32 |
| 31 | FP32*FP32 | FP16 |
| 32 | | BF16 |
| 33 | | FP32 |
| 41 | FP32*BF16 | FP16 |
| 42 | | BF16 |
| 43 | | FP32 |

Different from computation mode numbers shown in Table 2, computation modes in Table 3 are extended one bit for indicating the data format after floating-point multiplication computation. For example, when operated in a computation mode 21, the multiplier executes a floating-point computation to the two input floating-point numbers BF16*BF16 and output a data format in a type of FP16 after the floating-point multiplication computation.

The above using of the computation modes in the form of number to indicate the floating-point data format is only exemplary but not restrictive. According to the teaching of the present disclosure, it is also conceivable to establish an index according to the computation mode to determine a format of a multiplier and a format of a multiplicand. For example, the computation mode includes two indexes. A first index is configured to indicate a type of the first floating-point number, and a second index is configured to indicate a type of the second floating-point number. For example, a first index “1” in a computation mode 13 indicates the first floating-point number (or called as the multiplicand) as a first floating-point format, and a second index “3” in the computation mode 13 indicates the second floating-point number (or called as the multiplier) as a second floating-point format, which is the FP32. Further, a third index may be added to the computation mode, and the third index indicates a data format of an output result. For example, a third index “1” in a computation mode 131 may indicate a data format of the output result as the first floating-point format, which is the FP16. When a count of computation modes increases, a corresponding indexes or index layers may be added according to a need to establish a relation between the computation mode and the data format.

In addition, although a numerical number is used here to indicate the computation mode as an example, in other examples, the computation mode may also be indicated by other signs or numbers according to application requirements. For example, expressions as letters, signs, numbers or combinations thereof may be used to indicate the computation mode, which may identify the data format of the first floating-point number, the data format of the second floating-point number and the data format of the output result. In addition, when these expressions are formed in the form of instruction, the instruction may include three domains or fields. A first domain is configured to indicate the data format of the first floating-point number, and a second domain is configured to indicate the data format of the second data format, and a third domain is configured to indicate the data format of the output result. Certainly these domains may be merged to one domain, or a new domain may be added to indicate more contents about the floating-point data format. It may be seen that computation modes of the present disclosure may not only be associated with the input floating-point number data format, but may also be applied to normalize the output result to obtain a multiplication result with an expected data format.

FIG. 3 is a structural block diagram of more details of a multiplier 300, according to an embodiment of the present disclosure. It may be seen from FIG. 3 that the multiplier 300 not only includes the exponent processing unit 202, the mantissa processing unit 204 and the sign processing unit 206 that is optional in FIG. 2, but also shows internal components of these units and units associated with operations of these units. Exemplary operations of these units are described in detail below with reference to FIG. 3.

In order to execute the multiplication computation of floating-point numbers, the exponent processing unit may be configured to obtain the exponent after the multiplication computation according to the above-mentioned computation mode, exponent of the first floating-point number and exponent of the second floating-point number. In an embodiment, the exponent processing unit may be implemented through an adder and subtracter circuit. For example, the exponent processing unit here may be configured to obtain exponents of the first floating-point number and exponents of the second floating-point number after the multiplication computation by first respectively summing the exponent of the first floating-point number and the exponent of the second floating-point number and offsets of corresponding input floating-point data format, and second respectively subtracting offsets of corresponding output floating-point data format.

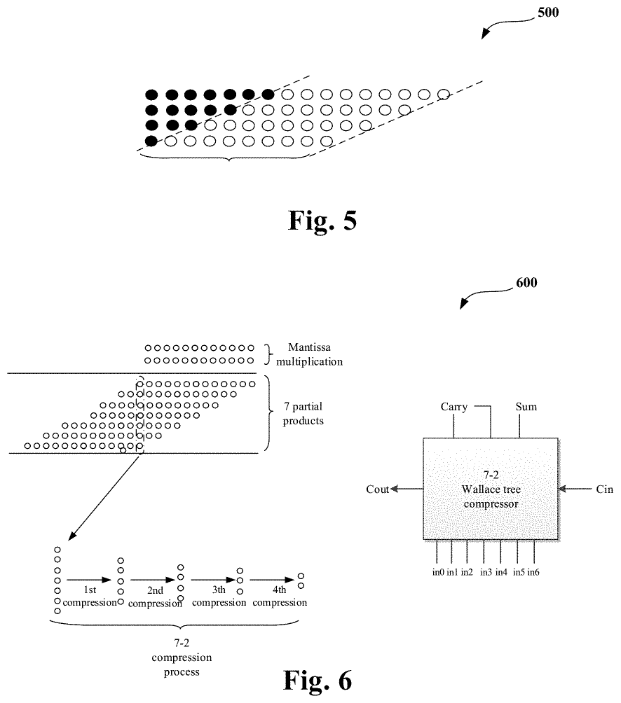

Further, the mantissa processing unit of the multiplier may be configured to obtain the mantissa after the multiplication computation according to the above-mentioned computation mode, the first floating-point number and the second floating-point number. In an embodiment, the mantissa processing unit may include a partial product computation unit 312 and a partial product summation unit 314, where the partial product computation unit is configured to obtain an intermediate result according to the mantissa of the first floating-point number and the mantissa of the second floating-point number. In some embodiments, the intermediate result may be a plurality of partial products (as shown illustratively in FIG. 5 and FIG. 6) obtained during the multiplication of the first floating-point number and the second floating-point number. The partial product summation unit is configured to sum intermediate results to obtain a summation result, and take the summation result as the mantissa after the multiplication computation.

In order to obtain the intermediate result, in an embodiment, the present disclosure uses the Booth encoding circuit to add zeros to a high bit and a low bit (where adding zeros to the high bit is transforming the mantissa from an unsigned number to a signed number) of the mantissa of the second floating-point number (if the second floating-point number is the multiplier in the floating-point computation) to obtain the intermediate result. It needs to be understood that the mantissa of the first floating-point number (for example, the first floating-point number is the multiplicand in the floating-point computation) may be encoded (such as adding zeros to the high bit and the low bit) according to different methods of encoding, or both the mantissa of the first floating-point number and the mantissa of the second floating-point number may be encoded to obtain the plurality of partial products. More detailed description about the partial product may be explained below by referring to the drawings.

In another embodiment, the partial product summation unit may include an adder, and the partial product summation unit is configured to sum the intermediate results to obtain the summation result. In another embodiment, the partial product summation unit may include a Wallace tree and an adder, where the Wallace tree is configured to sum the intermediate results to obtain a second intermediate result, and the adder is configured to sum second intermediate results to obtain the summation result. In these embodiments, the adder may include at least one of adders including a full adder, a serial adder and a carry-lookahead adder.

In an embodiment, the mantissa processing unit may include a control circuit 316, which is configured to call the mantissa processing unit multiple times according to the computation mode when the computation mode indicates that a mantissa bit width of at least one of the first floating-point number or the second floating-point number is larger than a data bit width processable at one time by the mantissa processing unit. The control circuit may be implemented as a control signal in an embodiment. For example, the control circuit may be a counter, a control flag, and the like. To implement a plurality of callings here, the partial product summation unit may include a shifter. When the control circuit calls the mantissa processing unit multiple times according to the computation mode, the shifter is configured to shift an existing summation result in each calling and add the result to a summation result obtained in this calling to obtain a new summation result, and take a new summation result obtained in a last calling as the mantissa of the multiplication computation.

In an embodiment, the multiplier of the present disclosure further includes a normalization unit 318 and a rounding unit 320. The normalization unit may be configured to execute floating-point number normalization processing to the mantissa and the exponent after the multiplication computation to obtain a normalized exponent result and a normalized mantissa result, take the normalized exponent result as the exponent after the multiplication computation, and take the normalized mantissa result as the mantissa after the multiplication computation. For example, the normalization unit may adjust bit widths of the exponent and the mantissa according to the data format indicated by the computation mode to make the data bit widths of the exponent and the mantissa meet the requirement of the above-mentioned indicated data format. In addition, the normalization unit may also adjust other aspects of the exponent or the mantissa. For example, in some application scenarios, when the value of the mantissa is not 0, the highest significant bit of the mantissa bit should be 1; otherwise, the normalization unit may modify the exponent bit and shift the mantissa bit at the same time to make the mantissa in the form of a normalized number. In another embodiment, the normalization unit may adjust the exponent after the multiplication computation according to the mantissa after the multiplication computation. For example, when the highest bit of the mantissa after the multiplication computation is 1, the normalization unit may add 1 to the exponent obtained after the multiplication computation. Correspondingly, the rounding unit may execute a rounding operation to the normalized mantissa result according to a rounding mode and set the mantissa after the rounding operation as the mantissa after the multiplication computation. According to different application scenarios, the rounding unit may execute rounding operations such as rounding down, rounding up and rounding to the nearest significant number. In some application scenarios, the rounding unit may also round the 1 moved out in the process of shifting the mantissa to the right.

Except for the exponent processing unit and the mantissa processing unit, the multiplier of the present disclosure may optionally include a sign processing unit. When the input floating-point number is a floating-point number with a sign bit, the sign processing unit may be configured to obtain a sign after the multiplication computation according to a sign of the first floating-point number and a sign of the second floating-point number. For example, in an embodiment, the sign processing unit may include an exclusive-OR logical circuit 322, which is configured to execute an exclusive computation according to the sign of the first floating-point number and the sign of the second floating-point number to obtain the sign after the multiplication computation. In another embodiment, the sign processing unit may be implemented through a truth table or a logical judgment.

In addition, in order to make the input or received first and second floating-point numbers conform to a defined format, in an embodiment, the multiplier of the present disclosure may further include a normalization processing unit 324. When the first floating-point number or the second floating-point number is a non-normalized and non-zero floating-point number, the normalization processing unit 324 is configured to perform normalization processing on the first floating-point number or the second floating-point number according to the computation mode to obtain a corresponding exponent and a corresponding mantissa. For example, when a selected computation mode is a second computation mode shown in Table 2, and the input first and the second floating-point number are the FP16-type data, the normalization processing unit may be configured to normalize the FP16-type data to the BF16 type data to make the multiplier be operated in the second computation mode. In one or more embodiments, the normalization processing unit may be configured to pre-process a mantissa of the normalized floating-point number with an implicit 1 and a mantissa of the non-normalized floating-point number without an implicit 1 (such as extending the mantissa) for the convenience of a subsequent operation of the mantissa processing unit. Based on the above description, it may be understandable that the normalization processing unit 324 here and the above-mentioned normalization unit 318 may execute same or similar operations in some embodiments. What is different is that the normalization unit 324 is configured to normalize the input floating-point data, but the normalization unit 318 is configured to normalize the about to output mantissa and exponent.

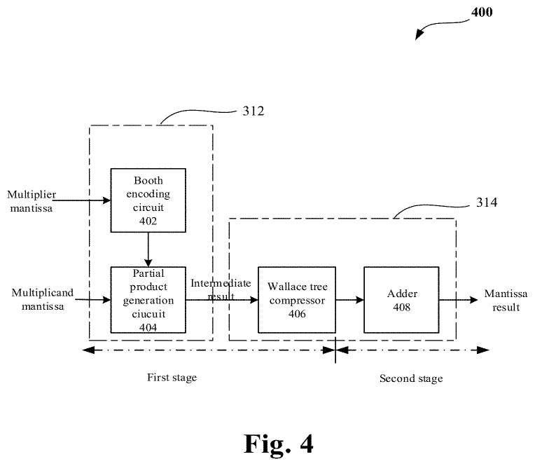

The multiplier of the present disclosure and various embodiments thereof have been described above with reference to FIG. 3. Based on the above description, those skilled in the art may understand that in the solutions of the present disclosure, the result (exponents, mantissas and optional signs) after the multiplication computation may be obtained through an execution of the multiplier. According to different application scenarios, for example, when the above-mentioned normalization processing and the rounding processing are not required, a result obtained through the mantissa processing unit and the exponent processing unit may be seen as a final computation result. Further, when the above-mentioned normalization processing and rounding processing are required, the exponent and mantissa obtained through the normalization processing and rounding processing may be seen as the final computation result or part of the final computation result (when considering a final sign). Further, the solutions of the present disclosure use various computation modes to make the multiplier support the computation of different floating-point numbers with different types or data formats, thereby implementing reusing of the multiplier, and then saving an overhead of a chip design and a computation cost. In addition, through a plurality-of-calling mechanism, the multiplier of the present disclosure may support a computation of floating-point number with a high bandwidth. Given that in the floating-point number multiplication, a multiplication of the mantissa (or called as the mantissa bit or a mantissa part) is very important to a performance of a whole floating-point computation. The mantissa operation of the present disclosure may be described by referring to FIG. 4.

FIG. 4 is a schematic block diagram of a mantissa processing unit operation 400, according to an embodiment of the present disclosure. As shown in FIG. 4, the mantissa processing operation may mainly involve two units, which are the above-mentioned partial product computation unit and the partial product summation unit discussed by referring to FIG. 3. From the perspective of operation timing, the mantissa processing operation may be divided into a first stage and a second stage. In the first stage, the mantissa processing operation may obtain the intermediate result, and in the second stage, the mantissa processing operation may obtain a mantissa result output from an adder 408.

In an exemplary specific operation, the first floating-point number and the second floating-point number that are received by the multiplier may be divided into a plurality of parts, which are the above-mentioned sign (which is optional), exponent and mantissa. Optionally, after the normalization processing, mantissa parts of the two floating-point numbers may enter the mantissa processing unit (the mantissa processing unit shown in FIG. 2 or FIG. 3) as inputs, and specifically enter the partial product computation unit. As shown in FIG. 4, the present disclosure uses a Booth encoding circuit 402 to add zeros to the high bit and the low bit of the mantissa of the second floating-point number (which is the multiplier in the floating-point computation) and to execute Booth encoding processing, thereby obtaining the intermediate result in a partial product generation circuit 404. Certainly, the first floating-point number and the second floating-point number here are only used for illustrative but not restrictive purposes. Therefore, in some application scenarios, the first floating-point number may be the multiplier, and the second floating-point number may be the multiplicand. Correspondingly, in some encoding processing, an encoding operation may be executed on the floating-point number that serves as the multiplicand.

In order to better understand the technical solutions of the present disclosure, the Booth encoding may be briefly introduced below. Generally, when two binary numbers are multiplied together, a plurality of intermediate results called partial products may be generated through the multiplication, and then the final result of the multiplication of two binary numbers may be obtained by accumulating these partial products, where the greater the number of partial products, the greater the area and power consumption of an array multiplier, the slower the execution speed, and the more difficult it is to execute the circuit. However, a purpose of the Booth encoding is to effectively reduce the number of sum terms of partial products, thereby reducing a circuit area. An algorithm of the Booth encoding is to first encode the input multiplier according to corresponding regulations. In an embodiment, for example, encoding regulations may be regulations shown in Table 4 below.

TABLE 4

| To-be-coded data | | | Encoding signal |
|---|---|---|---|
| y_{2i + 1} | y₂ᵢ | y_{2i - 1} | PPi |
| 0 | 0 | 0 | 0 |
| 0 | 0 | 1 | X |
| 0 | 1 | 0 | X |
| 0 | 1 | 1 | 2X |
| 1 | 0 | 0 | −2X |
| 1 | 0 | 1 | −X |
| 1 | 1 | 0 | −X |
| 1 | 1 | 1 | −0(=0) |

In Table 4, y2i+1, yi2 and y2i−1 may represent values corresponding to each group of to be coded sub-data (which is the multiplier), and X may represent the mantissa of the first floating-point number (which is the multiplicand). A corresponding encoding signal PPi (i=0, 1, n) may be obtained after executing the Booth encoding processing on each group of to be coded corresponding data. As illustratively shown in Table 4, the encoding signal obtained after the Booth encoding may include five categories, including −2X, 2X, −X, X and 0 respectively. Exemplarily, based on the above-mentioned encoding regulations, if the received multiplicand is 8-bit data “X₇X₆X₅X₄X₃X₂X₁X₀”, following partial products may be obtained:

1) when a multiplier bit includes three-bit-consecutive data “001” in Table 4, and the partial product is X and may be represented as “X₇X₆X₅X₄X₃X₂X₁X₀”, and the ninth bit is a sign bit, which is PPi={X[7], X};

2) when the multiplier bit includes three-bit-consecutive data “011” in Table 4, the partial product is 2X, which may be represented as X shifted one bit to the left to get “X₇X₆X₅X₄X₃X₂X₁X₀0”, which is PPi={X, 0};

3) when the multiplier bit includes three-bit-consecutive data “101” in Table 4, the partial product is −X and may be represented as “X̅₇̅X̅₆̅X̅₅̅X̅₄̅X̅₃̅X̅₂̅X̅₁̅X̅₀̅+1”, which means inverting “X₇X₆X₅X₄X₃X₂X₁X₀” bit by bit and then plus one, which is PPi=˜{X[7], X}+1;

4) when the multiplier bit includes three-bit-consecutive data “100” in Table 4, the partial product may be −2X and may be represented as “X̅₇̅X̅₆̅X̅₅̅X̅₄̅X̅₃̅X̅₂̅X̅₁̅X̅₀̅1̅+1”, which means shifting “X₇X₆X₅X₄X₃X₂X₁X₀” one bit to the left, inverting it and adding 1, which is PPi=˜{X, 0}+1;

5) when the multiplier bit includes three-bit-consecutive data “111” or “000” in Table 4, the partial product is 0, which is PPi={9′ b0}.

It should be understood that the above description of obtaining the partial product by referring to Table 4 is only exemplary and not restrictive. Under the teaching of the present disclosure, those of ordinary skill in the art may change regulations in Table 4 to obtain a partial product that is different from that shown in Table 4. For example, when there is specific data with a plurality of consecutive bits in the multiplier bit (for example, 3 bits or more), the obtained partial product may be a complement code to the multiplicand, or for example, the “plus 1” operation in the above mentioned 3) and 4) steps may be executed after summing the partial products.

It may be understood according to the above introductory description that encoding the mantissa of the second floating-point number through the Booth encoding circuit and by using the mantissa of the first floating-point number, the plurality of partial products may be generated from a partial product generation circuit, and these partial products may be set as the intermediate results and input into a Wallace treecompressor 406 in the partial product summation unit. It should be understood that obtaining the partial product through the Booth encoding is only a preferred method of the present disclosure, and those of ordinary skill in the art may also obtain the partial product through other methods. For example, the partial product may be obtained through a shift operation; in other words, corresponding partial product may be obtained through selecting whether shift plus the multiplicand or plus 0 according to whether the bit value of the multiplier is 1 or 0. Similarly, using a Wallace tree compressor to implement a summation operation of the partial products is only exemplary but not restrictive, and those of ordinary skill in the art may also consider using other types of adders to implement such partial products summation operation. For example, the adder may be one or a plurality of full adders, half adders or various combinations thereof.

The Wallace tree compressor (or the Wallace tree) is mainly configured to sum the above mentioned intermediate results (the plurality of partial products) to reduce cumulative frequency (which is the compression) of the partial products. Generally, the Wallace tree compressor may adopt a carry-save (CAS) architecture and a Wallace tree algorithm, and through using a Wallace tree array, the computation speed is faster than that of using traditional carry propagate summation.

Specifically, the Wallace tree compressor may execute a parallel computation on partial products of all lines. For example, the cumulative frequency of N partial products may be reduced from N−1 to Log 2N, thereby increasing a speed of the multiplier, which is of great significance to the effective use of resources. According to different application requirements, the Wallace tree compressor may be designed into a plurality of types, such as a 7-2 Wallace tree, a 4-2 Wallace tree, a 3-2 Wallace tree, and the like. In one or more embodiments, the present disclosure uses the 7-2 Wallace tree as an example to implement all kinds of floating-point computations, which may be described in detail below by referring to FIG. 5 and FIG. 6.

In some embodiments, the Wallace tree compression operation disclosed in the present disclosure may be set with M inputs and N outputs, and the number of Wallace trees may be no less than K, where N is a preset positive integer less than M, and K is a positive integer no less than the maximum bit width of the intermediate result. For example, M may be 7 and N may be 2, which is the number of 7-2 Wallace tree that may be described in detail below. When the maximum bit width of the intermediate result is 48, K may be a positive integer 48; in other words, the number of the Wallace tree may be 48.

In some embodiments, according to the computation mode, one or a plurality of groups of Wallace trees may be selected to sum the intermediate results, where each group includes X Wallace trees, and X is a bit number of the intermediate result. Further, a successive carry relationship exists between Wallace trees within one group, but there is no such relationship between each group. In an exemplary connection, the Wallace tree compressors may be connected through a carry. For example, a carry of a Wallace tree in the low bit may be input (such as Cin in FIG. 6) into a Wallace tree compressor in the high bit, and a carry input Cout of the Wallace tree compressor in the high bit may become the a carry input Cout received by a Wallace tree compressor in a higher bit from the Wallace tree compressor in the high bit. In addition, when selecting one or more Wallace tree compressors from a plurality of Wallace tree compressors, the selection may be arbitrary. For example, the Wallace tree compressors may be selected according to numerical order 0, 1, 2 and 3, or may be connected according to numerical order 0, 2, 4 and 6 as long as the selected Wallace tree compressors are selected according to the above mentioned carry relationship.

The above mentioned Wallace trees and the operation may be introduced through a combination of an illustrative example in the following. It is supposed that the first floating-point number and the second floating-point number are 16-bit data (for example, FP16*FP16), and the multiplier supports 32-bit data bit width (which means the multiplier may support a parallel multiplications of two groups of 16-bit data), and the Wallace tree compressor is a 7-2 Wallace tree compressor with 7 inputs (an exemplary value of the above mentioned M) and 2 (an exemplary value of the above mentioned N) outputs. In such exemplary scenario, 48 (an exemplary value of the above mentioned K) Wallace trees may be adopted to finish multiplication computation of two groups of data in parallel.

In the above mentioned 48 Wallace trees, the Wallace trees from the 0th to the 23rd (the 24 Wallace trees in the first group of Wallace tree) may finish a partial product summation of the first group of multiplication, and each Wallace tree in the group may be connected one by one through the carry. Further, the 24th to the 47^{th} Wallace trees (the 24 Wallace trees in the second group of Wallace trees) may finish a partial product summation of the second group of multiplication, and each Wallace tree in the group may be connected one by one through the carry. In addition, there is no carry relationship between a 23rd Wallace tree in the first group and a 24th Wallace tree in the second group; in other words, there is no carry relationship between Wallace trees in different groups.

Back to FIG. 4, after summing and compressing the partial product through the Wallace tree compressor, a result of the mantissa multiplication operation may be obtained by summing compressed partial products through the adder. Regarding the adder, in one or a plurality of embodiments of the present disclosure, the adder may include one of adders including the full adder, the serial adder and the carry-lookahead adder. The adder is configured to sum a last two lines of partial products obtained through summation of the Wallace tree compressors to obtain the result of the mantissa multiplication operation.

It may be understood that through the mantissa multiplication shown in FIG. 4, especially using the Booth encoding and the Wallace tree exemplarily, the result of the mantissa multiplication operation may be obtained effectively. Specifically, the Booth encoding processing may effectively reduce the number of the partial product sum terms, thereby reducing the circuit area. The Wallace tree compressor may compute a sum of the partial products in each line in parallel, thereby increasing the speed of the multiplier.

The exemplary operation process of the partial product and the 7-2 Wallace tree may be described in detail below by referring to FIG. 5 and FIG. 6. It may be understood that the description here is only exemplary and not restrictive, and is only for a better understanding of the solutions of the present disclosure.

FIG. 5 shows a partial product 500 obtained after passing through the partial product generation circuit in the mantissa processing unit described by referring to FIG. 2 to FIG. 4. Four lines of white spots are located between two dotted lines, where each line of white spots identifies a partial product. For the convenience of subsequent execution of the Wallace tree, the bit number may be extended in advance. For example, black spots in FIG. 5 are copied highest bit values of each 9-bit partial product. It may be seen that partial products are extended and aligned to 16 (8+8) bits (8 bits of the bit width of the multiplicand mantissa plus 8 bits of the bit width of the multiplier mantissa). In another embodiment, for example, a partial product of a 25*13 binary multiplication is extended to 38 (25+13) bits (25 bits of the mantissa of the multiplicand plus 13 bits of the bit width of the mantissa of the multiplier).

FIG. 6 is a schematic diagram 600 and an operation process of a Wallace tree compressor according to an embodiment of the present disclosure.

As shown in FIG. 6, after executing multiplication operation on mantissas of two floating-point numbers, as mentioned before, seven partial products shown in FIG. 6 may be obtained by encoding the multiplier through the Booth encoding and passing through the multiplicand. Because of the using of a Booth encoding algorithm, a count of generated partial products is reduced. For a better understanding, a Wallace tree including seven elements is identified by dashed boxes in the partial product part in FIG. 6. Further, arrows are used to identify the process of compressing the Wallace tree from seven elements to two elements. In an embodiment, the compression process (or the summation process) may by implemented through the full adder, which means inputting three elements and outputting two elements (a carry to a high bit and a sum). The schematic diagram of the 7-2 Wallace tree compressor is shown on the right side of FIG. 6. It is understandable that the Wallace tree compressor includes 7 inputs from a column of partial products (the seven elements identified by dashed boxes on the left part of FIG. 6). In an operation, the carry input of the 0th column Wallace tree is 0, and the carry cout of each column of Wallace tree may be the carry input Cin of Wallace tree in the next column.

It may be seen from the left side of FIG. 6 that after four times of compressions, the Wallace tree including 7 elements may be compressed into the Wallace tree including 2 elements. As mentioned before, the present disclosure uses the 7-2 Wallace tree compressor to compress a seven-line partial product to a two-line partial product (the second intermediate result of the present disclosure), and the present disclosure uses the adder (such as the carry-look ahead adder) to obtain the mantissa result.

To further explain principles of the solutions of the present disclosure, the following may describe exemplarily how the multiplier finishes operations in a first stage under four types of computation modes FP16*FP16, FP16*FP16, FP32*FP32 and FP32*BE16, which means obtaining the second intermediate result until the Wallace tree compressor finish the summation of the intermediate results.

### (1) FP16*FP16

Under the computation mode of the multiplier, the mantissa bit of the floating-point number is 10 bits, and considering a non-normalization and non-zero number under the IEEE754 standard, the mantissa bit may be extended by 1 bit and become 11 bits. In addition, the mantissa bit is an unsigned number, when using the Booth encoding algorithm, 1 bit 0 may be extended on the high bit; therefore, a total mantissa bit is 12 bits. When executing the Booth encoding on the second floating-point number with reference to the first floating-point number, 7 partial products may be obtained on the high bit and the low bit through the partial product generation circuit respectively. The 7th partial product is 0, and the bit width of each partial product is 24 bits. At this point, 48 7-2 Wallace trees may be used to execute compression, and a carry from the 23rd to the 24th Wallace tree is 0.

### (2) BF16*BF16

Under the computation mode of the multiplier, the mantissa bit of the floating-point number is 7, considering the non-normalization and non-zero number and extending the number to be the signed number under the IEEE754 standard, the mantissa bit may be extended to 9 bits. When executing the Booth encoding on the second floating-point number with reference to the first floating-point number, 7 effective partial products may be obtained on the high bit and the low bit respectively through the partial product generation circuit. The 6th and the 7th partial product are 0, and the bit width of each partial product is 18 bits. At this point, two groups of 7-2 Wallace trees, from 0th to a 17th, and from 24th to 41st may be used to execute compression, where the carry from the 23rd and the 24th Wallace tree is 0.

### (3) FP32*FP32

Under the computation mode of the multiplier, the mantissa bit of the floating-point number is 23, considering the non-normalization, non-zero number principle under the IEEE754 standard, the mantissa bit may be extended to 24 bits. To save an area of a multiplication unit, the multiplier of the present disclosure may be called twice under the computation mode to finish one computation. To this end, the multiplication of the mantissa bit of every time is 25 bit*13 bit, which means extending the first floating-point number ina by 1 bit 0 to a 25-bit signed number, and separating the 24-bit mantissa bit of the second floating-point number inb into 12 bits in the high bit and 12 bits in the low bit, and then respectively extending 1 bit 0 of them to obtain two multipliers with 13 bits, which are represented as inb_high13 in high bit and inb_low13 in low bit. In a specific operation, the multiplier of the present disclosure is called to compute the ina*inb_low13 at the first time, and called to compute the ina*inb_high13 at the second time. In every computation, the 7 effective partial products are generated through the Booth encoding, and each of the partial product has a bit width of 38 bits and compressed by a 0th to 37th 7-2 Wallace trees.

### (4) FP32*BF16

Under the computation mode of the multiplier, the mantissa bit of the first floating-point number ina is 23 bits, and the mantissa bit of the second floating-point number inb is 7 bits. Considering the non-normalization and non-zero number and extending the number to be the signed number under IEEE754 standard, the mantissa bit of the first floating-point number and the second floating-point number may be extended to 25 bits and 9 bits respectively to execute 25 bit*9 bit multiplication to obtain the 7 effective partial products. The 6th and the 7th partial products are 0, and each partial product has a bit width of 34 bits, and these partial products are compressed through the 0th to the 33rd Wallace tree.

The above, through specific examples, describes how the multiplier of the present disclosure finishes the first stage operation under the four computation modes, where the Booth encoding algorithm and the 7-2 Wallace tree are preferred methods. Based on the above description, those of ordinary skill in the art may understand that the present disclosure uses 7 partial products to reuse the 7-2 Wallace tree in different computation modes.

In some computation modes, the mantissa processing unit may include a control circuit, which is configured to call the mantissa processing unit multiple times when the mantissa bit width of the first floating-point number indicated by the computation mode and/or the mantissa bit width of the first floating-point number is larger than a data bit width that may be processed at one time by the mantissa processing unit. Further, for the cases of plurality of callings, the partial product summation circuit may include a shifter. When calling the mantissa processing unit multiple times according to the computation mode, under the case that the summation result is existing, the shifter is configured to shift the existing summation result, and add the result to a summation result obtained in this calling to obtain a new summation result, and take the new summation result as the mantissa after the multiplication computation.

For example, as mentioned before, the mantissa processing unit may be called twice in the FP32*FP32 computation mode. Specifically, when calling the mantissa processing unit for the first time, the mantissa bit (ina*inb_low13) obtains a second low bit intermediate result in the second stage through addition of carry lookahead adders, and when calling the mantissa processing unit for the second time, the mantissa bit (ina*inb_high13) obtains a second high bit intermediate result in the second stage through addition of carry lookahead adders. After that, in an embodiment, a shift operation of the shifter may be used to accumulate the second low bit intermediate result and the second high bit intermediate result to obtain the mantissa after the multiplication computation, and the shift operation may by represented as follows:

r_{fp32×fp32}=sumₕ[37:0]<<12+sumₗ[37:0]

The second high bit intermediate result sumₕ [37:0] is shifted 12 bits to the left and added to the second low bit intermediate result sumₗ [37:0].

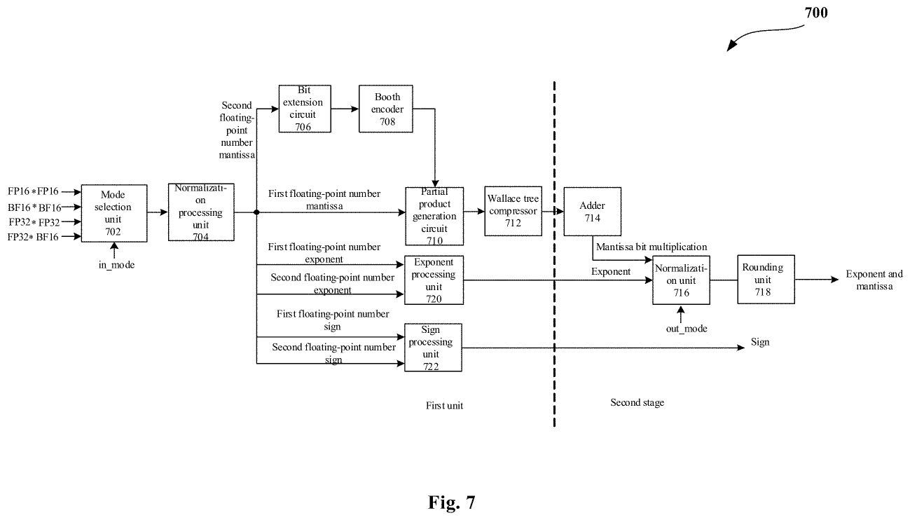

By referring to FIG. 4 to FIG. 6, the above description describes operations executed by the multiplier of the present disclosure to the mantissas of the first floating-point number and the second point number when performing floating-point computation. Certainly, to focus on describing operations of the mantissa processing unit of the multiplier of the present disclosure, FIG. 4 does not describe other units like the exponent processing unit and the sign processing unit. The following may describe the multiplier of the present disclosure in general, and the above description about the mantissa processing unit may also apply to what is described in FIG. 7.

FIG. 7 is an entire block diagram of the multiplier 700 according to an embodiment of the present disclosure. It should be understood that positions, existences and connection relationships of all types of units drawn in the figure are only exemplary but not restrictive. For example, some of the units may be integrated, and some other units may be separated or be omitted or be replaced according to different application scenarios.

The multiplier of the present disclosure in operations of every computation mode may be exemplarily divided into a first stage and a second stage according to an operation process, as drawn by dotted lines in the figure. Generally speaking, the first stage includes outputting the computation result of the sign bit, the intermediate computation result of the exponent bit, the intermediate computation result of the mantissa bit (for example, including the encoding process of an input mantissa bit fixed-point multiplication Booth encoding for inputting the mantissa bit and the compression process of the Wallace tree). The second stage includes normalizing and rounding the exponent and the mantissa to output the computation result of the exponent and to output the computation result of the mantissa.

As shown in FIG. 7, the multiplier of the present disclosure may include a mode selection unit 702 and a normalization processing unit 704, where the mode selection unit may choose the computation mode according to an input mode signal (in_mode). In an embodiment, the input mode signal may correspond to the computation mode number in Table 2. For example, when the input mode signal indicates computation mode number “1” in Table 2, the multiplier may work under the FP16*FP16 computation mode, and when the input mode signal indicates computation mode number “3” in Table 2, the multiplier may work under the FP32*FP32 computation mode. For the purpose of illustration, FIG. 7 only shows four types of exemplary computation modes: FP16*FP16, BF16*BF16, FP32*FP32 and FP32*BP16. However, just as mentioned before, the multiplier of the present disclosure also supports other various types of computation modes.

The normalization processing unit may be configured to normalize the first floating-point number or the second floating-point number according to the computation mode to obtain the corresponding exponent and mantissa when the first floating-point number or the second floating-point number is non-normalized non-zero floating-point number, such as normalizing the floating-point number of the data format indicated by the computation mode according to the IEEE754 standard.

Further, the multiplier includes the mantissa processing unit configured to execute the multiplication of the mantissa of the first floating-point number and the mantissa of the second floating-point number. Therefore, in one or more embodiments, the mantissa processing unit may include a bit extension circuit 706, a Booth encoder 708, a partial product generation circuit 710, a Wallace tree compressor 712 and an adder 714, where the bit extension circuit may be configured to extend the mantissa under the non-normalization non-zero principle of the IEEE754 standard to make the number applicable to the operation of the Booth encoder. Descriptions of the Booth encoder, the partial product generation circuit, the Wallace tree compressor and the adder have been made by referring to FIG. 4 to FIG. 6, so that same descriptions are applicable here and may not be repeated.

In some embodiments, the multiplier of the present disclosure may include a normalization unit 716 and a rounding unit 718. The normalization unit and the rounding unit have the same function as units shown in FIG. 3. Specifically, the normalization unit may execute floating-point number normalization processing to the summation result and the exponent data from the exponent processing unit according to the indicated data format by the output mode signal “out_mode” shown in FIG. 7 to obtain the normalization exponent result and the normalization mantissa result. For example, the normalization unit may adjust the bit width of the exponent and the bit width of the mantissa according to the data format indicated by the output mode signal to make the exponent and the mantissa meet the requirement of the above mentioned indicated data format. For another example, when the highest bit of the mantissa is 0, and the mantissa is not 0, the normalization unit may repeat the operation of shifting the mantissa by 1 bit to the left and subtracting 1 from the exponent until the value of the highest bit equals 1. For the rounding unit, in an embodiment, the rounding unit may be configured to execute a rounding operation to the normalized mantissa result according to a rounding mode to obtain the mantissa after the rounding operation, and set the mantissa after the rounding operation as the mantissa after the multiplication computation.

In one or more embodiments, the above-mentioned output mode signal may be a part of the computation mode and is configured to indicate the data format after the multiplication computation. For example, as described in Table 3, when the computation mode number is “12”, number “1” equals to the above mentioned “in_mode” signal and is configured to indicate execution of the FP16*FP16 multiplication, and number “2” equals to “out_mode” signal and is configured to indicate that the data type of the output result is BF16. It should be understood that in some application scenarios, the output mode signal may be merged with the above mentioned input mode signal so as to be provided to the mode selection unit. Based on this merged mode signal, the mode selection unit may define the data format of the input data and the data format of the output result at the beginning of the multiplication, but does not need to provide an output mode signal to the normalization only, which may further simplify the operation.

In one or more embodiments, the above mentioned rounding operation may exemplarily include the following five types of rounding modes.

(1) Rounding to the nearest value: under this mode, when two values are equally near, an even number may be taken first. At this time, the result may be rounded to the nearest value that may be representable. However, when there are two equally near values, the even number may be taken as the rounding result (a 0-terminated number in binary);

(2) Rounding up and rounding down: exemplary operations may be referred to the following examples;

(3) Rounding to a +∞ direction: under this regulation, the result may be rounded to a positive infinity;

(4) Rounding to a −∞ direction: under this regulation, the result may be rounded to a negative infinity; and

(5) Rounding to a 0 direction: under this regulation, the result may be rounded to 0.

A mantissa rounding example under the rounding mode: 24-bit mantissas of two normalized floating-point numbers are multiplied to obtain a 48 (47-0) bits mantissa, and after normalization (if the highest bit of the mantissa is 0, the mantissa may be shifted by 1 bit to the left; and if the highest bit of the mantissa is 1, the mantissa may not be shifted, and 1 may be added to the above temporary exponent obtained earlier), this mantissa may only be taken from the 46th bit to the 24th bit. When the 23rd bit of the mantissa is 0, the (23-0) bit may by rounded down; and when the 23rd bit of the mantissa is 1, 1 may be carried to the 24th bit and the (23-0) bit may be rounded down.

Returning to FIG. 7, the multiplier of the present disclosure also includes an exponent processing unit 720 and a sign processing unit 722, where the exponent processing unit may be configured to obtain the exponent after the multiplication computation according to the computation mode, the exponent of the first floating-point number and the exponent of the second floating-point number. For example, the exponent processing circuit may add data of the exponent bit of the first floating-point number and data of the exponent bit of the second floating-point number to corresponding offsets of the input floating-point data type, and then respectively subtract the offset of corresponding output floating-point data type to obtain data of the exponent bit of the multiplication of the first floating-point number and the second floating-point number. In one or more embodiments, the exponent processing unit may be implemented as or include an adder and subtracter circuit, which is configured to obtain an exponent after the multiplication computation according to the exponent of the first floating-point number, the exponent of the second floating-point number and the computation mode.

The sign processing unit may be implemented as an exclusive-OR circuit in an embodiment, which is configured to execute an exclusive OR operation to the sign bit of the first floating-point number and the sign bit of the second floating-point number to obtain data of the sign bit of the multiplication of the first floating-point number and the second floating-point number.

The multiplier of the present disclosure is described in detail before by referring to FIG. 7. Through this description, those of ordinary skill in the art may understand that the multiplier of the present disclosure supports operation under various computation modes, thereby overcoming the defect that multiplier of the prior art only supports single floating-point type computation. Further, the multiplier of the present disclosure may be reused, so that floating-point type data with high bit width may be supported, which reduces computation costs and overheads. In one or more embodiments, the multiplier of the present disclosure may be arranged or included in an integrated circuit chip or the computation apparatus to execute multiplication computation to the floating-point number under various computation modes.

On the other hand, the multiplier of the present disclosure may support parallel multiplication operation of a plurality of groups of floating-point numbers, and the plurality of groups of floating-point numbers include the first floating-point number and the second floating-point number. The first floating-point numbers and the second floating-point numbers in each group of floating-point numbers may be spliced together and input into the multiplier, or may be just directly input into the multiplier. Each group of input floating-point numbers may respectively use the sign processing unit, the mantissa processing unit and the exponent processing unit to finish the multiplication computation of floating-point numbers. In addition, the multiplier may include a plurality of above mentioned sign processing units, mantissa processing units and exponent processing units, and the input each group of floating-point number may be processed through different sign processing units, mantissa processing units and exponent processing units. Certainly, the multiplier may include one or more sign processing units, one or more exponent processing units and one or more mantissa processing units, where numbers of three processing units may be combined arbitrarily. For example, the multiplier includes a plurality of sign processing units, a plurality of exponent processing units and a mantissa processing unit, where each group of floating-point numbers uses different sign processing units and different exponent processing units to process and successively uses the same mantissa processing unit to process. Further, for example, the mantissa processing unit may include a plurality of Wallace trees, which may be divided into a group or a plurality of groups of Wallace trees according to practical situation (such as the computation mode), and each group of Wallace trees is configured to process the mantissas of a group of floating-point numbers. For example, the plurality of Wallace trees are divided into two groups of Wallace trees, and each group of Wallace trees supports computation of two 16-bit mantissas; for example, if the first floating-point number and the second floating-point number in each group of floating-point numbers in the two groups of Wallace trees are 16 bits, the Wallace tree in this multiplier supports parallel operation of these two 16-bit mantissas. However, the mantissa processing unit may further include a plurality of other components (such as the Booth encoding circuit and the like), and other components (such as the Booth encoding circuit and the like) in each group are configured to process mantissas of a group of floating-point numbers. Certainly, the components of the mantissa processing unit may be called multiple times and do not need to be set for multiple numbers. In addition, the first floating-point number and the second floating-point number in each group of floating-point numbers may be spliced together and input into the multiplier.

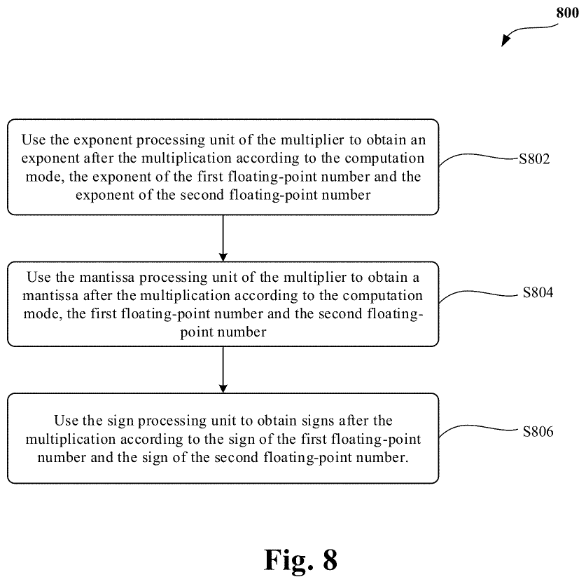

FIG. 8 is a flowchart of a method 800 of performing a floating-point number multiplication computation by using a multiplier, according to an embodiment of the present disclosure. It may be understood that the multiplier described here is the multiplier described above in detail by referring to FIG. 1 to FIG. 7, so that the above descriptions about the internal composition, function and operation of the multiplier are also applicable here.

As shown in FIG. 8, the method 800 may also include the obtained exponent after the multiplication computation according to the computation mode, the exponent of the first floating-point number and the exponent of the second floating-point number at the step S802 through using the exponent processing unit of the multiplier. As mentioned before, the computation mode may be one of the various computation modes, and the computation mode may be configured to indicate the data format of the floating-point number. In one or more embodiments, the computation mode may also be configured to define the data format of the floating-point number of the output result.

Further, at the step S804, the method 800 may use the mantissa processing unit of the multiplier to obtain a mantissa after the multiplication computation according to the computation mode, the first floating-point number and the second floating-point number. For exemplary operations about the mantissa, the present disclosure uses the Booth encoding algorithm and the Wallace tree compressor in some preferred embodiments, thereby improving an efficiency of a mantissa processing. In addition, when the first floating-point number and the second floating-point number are signed numbers, the method 800 may also be configured to obtain the sign after the multiplication computation according to the sign of the first floating-point number and the sign of the second floating-point number in the step S806.

Even though the above mentioned methods show using the multiplier of the present disclosure to perform multiplication computation of the floating-point number in the form of steps, the order of the steps does not mean steps of the method must be executed according to the described order, but may be executed in other orders or in a parallel way. In addition, for the purpose of simple description, other steps of the method 800 are not described here, but those of ordinary skill in the art may understand that the method may execute the various above descriptions with reference to FIG. 1 to FIG. 7 through using the multiplier.

In the above-mentioned embodiments of the present disclosure, description of each embodiment has its own emphasis. For a part that is not described in detail in one embodiment, related descriptions in other embodiments may be referred to. The technical features of the embodiments above may be randomly combined. For simple description, not all possible combinations of the technical features of the embodiments above are described. Yet, provided that there is no contradiction, combinations of these technical features fall within the scope of the description of the present specification.

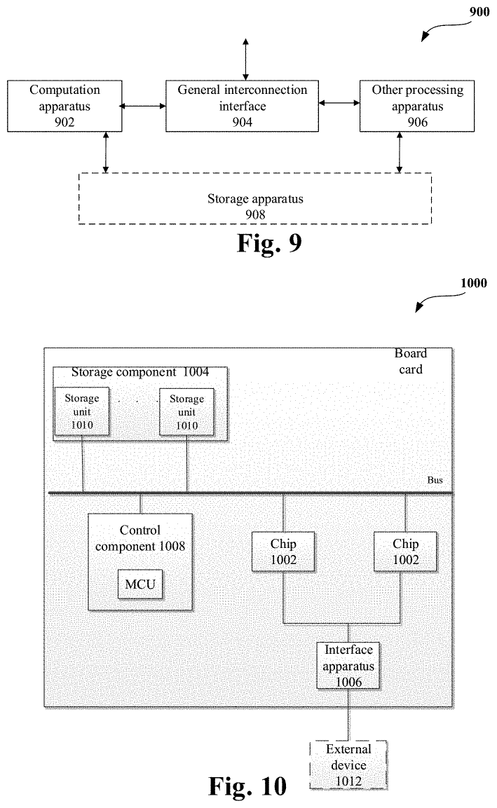

FIG. 9 is a structural diagram of a combined processing unit 900, according to an embodiment of the present disclosure. As shown in FIG. 9, the combined processing unit 900 includes a computation apparatus 902, which may include the above multiplier of the present disclosure described with reference to the drawings. In addition, the combined processing unit may also include a general interconnection interface 904 and other processing apparatus 906. The computation apparatus of the present disclosure interacts with other processing apparatus to jointly complete operations specified by the user.

According to the solutions of the present disclosure, other processing apparatus may include at least one or more of a general-purpose/special-purpose processors such as a central processing unit (CPU), a graphics processing unit (GPU), a neural network processor, and the like, and the number is not restrictive but needs to be determined according to actual needs. In one or more embodiments, other processing apparatus may serve as an interface that connects the computation apparatus of the present disclosure to external data and control to perform basic control, including but not limited to data moving, starting and stopping the machine learning computation apparatus; and other processing apparatus may also cooperate with the machine learning computation apparatus to complete computation task.

According to the solutions of the present disclosure, the general interconnection interface may also be configured to transmit data and control instructions between the computation apparatus and other processing apparatus. For example, the computation apparatus may obtain required input data from other processing apparatus through the general interconnection interface, and write the required input data to a storage apparatus of the computation apparatus. Further, the computation apparatus may obtain a control instruction from other processing apparatus through the general interconnection interface, and write the control instruction to a control cache of the computation apparatus. Alternatively, the general interconnection interface may read data in the storage unit of the computation apparatus and transmit the data to other processing apparatus.

The combined processing apparatus may also include a storage apparatus 908, which may be connected to the computation apparatus and other processing apparatus respectively. In one or more embodiments, the storage apparatus is configured to store data of the computation apparatus and other processing apparatus, and the storage apparatus is specifically applicable to the to-be-computed data that may not be entirely stored in the computation apparatus or internal storage of other processing apparatus.

According to different application scenarios, the combined processing apparatus of the present disclosure may be used as an SOC (system on chip) of a mobile phone, a robot, a drone, a video capture device, a video surveillance device, and the like, which may effectively reduce a core area of a control part, and increase the processing speed, and reduce the overall power consumption. In this case, the general interconnection interface of the combined processing apparatus may be connected to some components of the device. The components may include a camera, a monitor, a mouse, a keyboard, a network card, or a WIFI interface.

In some embodiments, the present disclosure also provides a chip or an integrated circuit chip, including the above mentioned computation apparatus, the combined processing apparatus and the multiplier of the present disclosure. In other embodiments, the present disclosure also provides a chip package structure, which includes the above mentioned chip.

In some embodiments, the present disclosure also provides a board card, which includes the above chip package structure. FIG. 10 shows the above mentioned exemplary board card, which not only includes the above mentioned chip 1002, but also includes other supporting components, which include but are not limited to: a storage component 1004, an interface apparatus 1006, and a control component 1008.

The storage component is connected to the chip in the chip package structure through a bus, and the storage device is configured to store data. The storage component may include a plurality of groups of storage units 1010. Each group of the storage units is connected to the chip through a bus. It may be understood that each group of storage units may be a DDR SDRAM (double data rate synchronous random access memory).

A DDR does not need to increase a clock frequency to double a speed of SDRAM. The DDR allows data to be read on the rising and falling edges of the clock pulse. The speed of DDR is twice that of a standard SDRAM. In an embodiment, the storage component may include 4 groups of storage units. Each group of storage units may include a plurality of DDR4 particles (chips). In an embodiment, four 72-bit DDR4 controllers may be included in the chip, where 64 bits in 72 bits of each DDR4 controller are for data transmission and 8 bits are for ECC (error checking and correcting).

In an embodiment, each group of the storage units may include a plurality of DDR SDRAMs arranged in parallel. The DDR may transmit data twice per clock cycle. A DDR controller may be arranged inside the chip. The DDR controller is configured to control the data transmission and the data storage of each storage unit.

The interface apparatus may be electrically connected to the chip inside the chip package structure. The interface apparatus is configured to implement data transmission between the chip and an external device 1012 (such as a server or a computer). For example, in an embodiment, the interface apparatus may be a standard PCIe (peripheral component interconnect express) interface. For example, data to be processed is transmitted from the server to the chip through a standard PCIe interface to realize data transmission. In another embodiment, the interface apparatus may also be other interfaces. The present disclosure does not restrict a specific form of other interfaces as long as the interface unit may realize a transferring function. In addition, a computation result of the chip is still sent back to the external device (such as a server) by the interface apparatus.

The control component is electrically connected to the chip to monitor a status of the chip. Specifically, the chip and the control component may be electrically connected through an SPI (serial peripheral interface). The control component may include an MCU (micro controller unit). For example, the chip may include a plurality of processing chips, processing cores, or processing circuits, and may drive a plurality of loads. Therefore, the chip may be in different working states such as a multi-load state and a light-load state. The control apparatus may realize regulation of working states of a plurality of processing chips, processing cores and/or processing circuits in the chip.

In some embodiments, the present disclosure provides an electronic device or apparatus, which includes the above mentioned board card. According to different application scenarios, the electronic device or apparatus may include a data processing apparatus, a robot, a computer, a printer, a scanner, a tablet, a smart terminal, a mobile phone, a traffic recorder, a navigator, a sensor, a webcam, a server, a cloud-based server, a camera, a video camera, a projector, a watch, a headphone, a mobile storage, a wearable device, a vehicle, a household appliance, and/or a medical device. The vehicle includes an airplane, a ship, and/or a car; the household appliance may include a television, an air conditioner, a microwave oven, a refrigerator, an electric rice cooker, a humidifier, a washing machine, an electric lamp, a gas cooker, and a range hood; and the medical device may include a nuclear magnetic resonance spectrometer, a B-ultrasonic scanner, and/or an electrocardiograph.

It should be noted that the above mentioned embodiments, for the sake of conciseness, are all described as a series of action combinations, but those skilled in the art should know that the present disclosure is not limited by the described order of action since some steps may be performed in a different order or simultaneously according to the present disclosure. Secondly, those skilled in the art should also understand that the embodiments described in the specification are all optional, and the actions and units involved are not necessarily required for this disclosure.

In the above-mentioned embodiments, descriptions of each embodiment have their own emphasis. For parts that are not described in detail in an embodiment, reference may be made to related descriptions of other embodiments.

In some embodiments of the present disclosure, it should be understood that the apparatus of the present disclosure may be implemented in other manners. The embodiments described above are merely illustrative, for example, the division of the unit is only a division of a logical function. In a real implementation, there may be other manners for division. For example, a plurality of units or components may be combined or may be integrated into another system, or some features may be ignored or not executed. In addition, coupling or direct coupling or communication connection between each illustrated or discussed component may be indirect coupling or communication connection through some interfaces, apparatus or units, and may be in the form of electrical, optical, acoustic, magnetic, and the like.

The units described as separate components may or may not be physically separated. The components shown as units may or may not be physical units. In other words, the components may be located in one place, or may be distributed into a plurality of network units. According to certain needs, some or all of the units may be selected for implementing the purposes of the embodiments of the present disclosure.

In addition, functional units in every embodiment of the present disclosure may be integrated into one processing unit, or each unit may be physically stand alone, or two or more units may be integrated into one unit. The integrated units above may be implemented in the form of hardware or in the form of software program unit.

When the integrated units are implemented in the form of a software program module and sold or used as an independent product, the integrated units may be stored in a computer-readable memory. Based on such understanding, the technical solutions of the present disclosure may be embodied in the form of a software product that is stored in a memory. The software product includes several instructions that enable a computer device (which may be a personal computer, a server, or a network device, and the like) to perform all or part of the steps of the methods described in the embodiments of the present disclosure. The above mentioned memory includes: a USB flash drive, a read-only memory (ROM), a random access memory (RAM), a mobile hard disk, a magnetic disk, or an optical disc, and other media that may store program codes.

The foregoing contents may be better understood according to the following articles:

Article A1. A multiplier configured to execute multiplication of a floating-point number according to a computation mode, wherein the floating-point number at least comprises an exponent and a mantissa, and the multiplier comprises: an exponent processing unit configured to obtain an exponent after the multiplication computation according to the computation mode, an exponent of a first floating-point number and an exponent of a second floating-point number; and a mantissa processing unit configured to obtain a mantissa after the multiplication computation according to the computation mode, a mantissa of the first floating-point number and a mantissa of the second floating-point number, wherein the computation mode is configured to indicate a data format of the first floating-point number and a data format of the second floating-point number.

Article A2. The multiplier of article A1, wherein the computation mode is further configured to indicate a data format after the multiplication computation.

Article A3. The multiplier of articles A1 or A2, wherein the data format includes at least one of numbers including a half-precision floating-point number, a single precision floating-point number, a brain floating-point number, a double precision floating-point number and a self definition floating-point number.

Article A4. The multiplier of any one of articles A1 to A3, wherein the floating-point number further includes a sign, and the multiplier further includes: a sign processing unit configured to obtain a sign after the multiplication computation according to a sign of the first floating-point number and a sign of the second floating-point number.

Article A5. The multiplier of any one of articles A1 to A4, wherein the sign processing unit includes an exclusive-OR logical circuit, which is configured to execute an exclusive-OR computation according to the sign of the first floating-point number and the sign of the second floating-point number to obtain the sign after the multiplication computation.

Article A6. The multiplier of any one of articles A1 to A5 further includes a normalization processing unit configured to normalize the first floating-point number or the second floating-point number according to the computation mode to obtain the corresponding exponent and mantissa when the first floating-point number or the second floating-point number is a non-normalized and non-zero floating-point number.

Article A7. The multiplier of any one of articles A1 to A7, wherein the mantissa processing unit includes a partial product computation unit and a partial product summation unit, wherein the partial product computation unit is configured to obtain an intermediate result according to the mantissa of the first floating-point number and the mantissa of the second floating-point number, and the partial product summation unit is configured to sum intermediate results to obtain a summation result, which may be set as the mantissa after the multiplication computation.

Article A8. The multiplier of any one of articles A1 to A7, wherein the partial product computation unit includes a Booth encoding circuit, which is configured to add zeros and execute a Booth encoding processing to a high bit and a low bit of the mantissa of the first floating-point number or the second floating-point number to obtain the intermediate result.

Article A9. The multiplier of any one of articles A1 to A8, wherein the partial product summation unit may include an adder, which is configured to sum the intermediate results to obtain the summation result.

Article A10. The multiplier of any one of articles A1 to A9, wherein the partial product summation unit includes a Wallace tree and the adder, wherein the Wallace tree is configured to sum the intermediate results to obtain a second intermediate result, and the adder is configured to sum second intermediates result to obtain the summation result.

Article A11. The multiplier of any one of articles A1 to A10, wherein the adder includes at least one of a full adder, a serial adder and a carry lookahead adder.

Article A12. The multiplier of any one of articles A1 to A11, wherein when a count of the intermediate result is less than M, zero values are added as the intermediate results to make the number of the intermediate results equals M, wherein M is a presupposed positive integer.

Article A13. The multiplier of any one of articles A1 to A12, wherein each Wallace tree has M inputs and N outputs, and a count of the Wallace trees is no less than K, wherein N is a presupposed positive integer less than M, and K is a positive integer that is no less than a largest bit width of the intermediate result.

Article A14. The multiplier of any one of articles A1 to A13, wherein the partial product summation unit is configured to select one group or a plurality of groups of Wallace trees to sum the intermediate results, wherein each group of Wallace trees has X Wallace trees, and X is a bit number of the intermediate result, wherein Wallace trees in each group have successive carry relationships, but there is no carry relationship between Wallace trees from different groups.

Article A15. The multiplier of any one of articles A1 to A14, wherein the mantissa processing unit includes a control circuit, which is configured to call the mantissa processing unit multiple times according to the computation mode when the computation mode indicates that a mantissa bit width of at least one of the first floating-point number or the second floating-point number is larger than a data bit width that is processable at one time by the mantissa processing unit.

Article 16. The multiplier of any one of articles A1 to A15, wherein the partial product summation unit also includes a shifter; when the control circuit calls the mantissa processing unit multiple times according to the computation mode, the shifter is configured to shift an existing summation result in each calling and add the result to a summation result obtained in this calling to obtain a new summation result, and take a new summation result obtained in a last calling as the mantissa of the multiplication computation.

Article A17. The multiplier of any one of articles A1 to A16 further includes a normalization unit configured to execute floating-point number normalization processing to the mantissa and the exponent after the multiplication computation to obtain a normalized exponent result and a normalized mantissa result, take the normalized exponent result as the exponent after the multiplication computation, and take the normalized mantissa result as the mantissa after the multiplication computation.

Article 18. The multiplier of any one of articles A1 to A17 further includes a rounding unit configured to execute rounding operation to the normalized mantissa result according to a rounding mode to obtain a mantissa after the rounding operation, wherein the mantissa after the rounding operation is set as the mantissa after the multiplication computation.

Article 19. The multiplier of any one of articles A1 to A18 further includes a mode selection unit configured to select the computation mode configured to indicate the data format of the first floating-point number and the data format of the second floating-point number from various computation modes supported by the multiplier.

Article A20. A method configured to execute multiplication computation of floating-point numbers through using a multiplier, wherein the floating-point numbers at least include an exponent and a mantissa, and the multiplier executes a multiplication computation based on a computation mode, and the method includes: using an exponent processing unit of the multiplier to obtain an exponent after the multiplication computation according to the computation mode, an exponent of a first floating-point number and an exponent of the second floating-point number;

using a mantissa processing unit of the multiplier to obtain a mantissa after the multiplication computation according to the computation mode, a mantissa of the first floating-point number and a mantissa of the second floating-point number; wherein the computation mode is configured to indicate a data format of the first floating-point number and a data format of the second floating-point number.

Article A21. An integrated circuit chip comprises the multiplier of any one of articles A1 to A19.

Article A22. A computation apparatus comprises the multiplier of any one of articles A1 to A19 or the integrated circuit chip of article A21.

The embodiments of the present disclosure are described in detail before. Specific examples are used in the specification to explain the principles and implementation manners of the present disclosure. The descriptions of the above embodiments are only used to facilitate understanding of the methods and core ideas of the present disclosure. In addition, persons of ordinary skill in the art may change the implementation and application scope according to the ideas of the present disclosure. In summary, the content of this specification should not be construed as a limitation on the present disclosure.

It should be understood that terms such as “first”, “second”, “third”, and “fourth” appear in the claims, the specification, and the drawings are used for distinguishing different objects rather than describing a specific order. It should be understood that the terms “including” and “comprising” used in the specification and the claims indicate the presence of a feature, an entity, a step, an operation, an element, and/or a component, but do not exclude the existence or addition of one or more other features, entities, steps, operations, elements, components, and/or collections thereof.

It should also be understood that the terms used in the specification of the present disclosure are merely for the purpose of describing particular embodiments rather than limiting the present disclosure. As being used in the specification and the claim of the present disclosure, unless the context clearly indicates otherwise, the singular forms “a”, “an”, and “the” are intended to include the plural forms. It should also be understood that the term “and/or” used in the specification and the claim refers to any and all possible combinations of one or more of relevant listed items and includes these combinations.

As being used in this specification and the claim, the term “if” may be interpreted as “when”, or “once” or “in response to a determination” or “in response to a case where something is detected” depending on the context. Similarly, depending on the context, the clause “if it is determined that” or “if [a described condition or event] is detected” may be interpreted as “once it is determined that”, or “in response to a determination”, or “once [a described condition or event] is detected”, or “in response to a case where [a described condition or event] is detected”.

The embodiments of the present disclosure are described in detail above, and specific examples are used to illustrate principles and implementations of the present disclosure. The descriptions of the above embodiments are only used to help understand the methods and core ideas of the present disclosure. Persons of ordinary skill in the art may change or transform the implementation and application scope according to the ideas of the present disclosure. The changes and transformations shall all fall within the protection scope of the present disclosure. In summary, the content of this specification should not be construed as a limitation of the present disclosure.

What is claimed:

1. A multiplier configured to execute a multiplication computation of a floating-point number according to a computation mode, wherein the floating-point number at least comprises an exponent and a mantissa, and the multiplier comprises:
an exponent processing unit configured to obtain an exponent after the multiplication computation according to the computation mode, an exponent of a first floating-point number and an exponent of a second floating-point number; and
a mantissa processing unit configured to obtain a mantissa after the multiplication computation according to the computation mode, a mantissa of the first floating-point number and a mantissa of the second floating-point number,
wherein the computation mode is configured to indicate a data format of the first floating-point number and a data format of the second floating-point number.

2. The multiplier of claim 1, wherein the computation mode is further configured to indicate a data format after the multiplication computation.

3. The multiplier of claim 1, wherein the data format includes at least one of numbers including a half-precision floating-point number, a single precision floating-point number, a brain floating-point number, a double precision floating-point number and a self definition floating-point number.

4. The multiplier of claim 1, wherein the floating-point number further includes a sign, and the multiplier further includes:
a sign processing unit configured to obtain a sign after the multiplication computation according to a sign of the first floating-point number and a sign of the second floating-point number.

5. The multiplier of claim 4, wherein the sign processing unit includes an exclusive-OR logical circuit, which is configured to execute an exclusive-OR computation according to the sign of the first floating-point number and the sign of the second floating-point number to obtain the sign after the multiplication computation.

6. The multiplier of claim 1, further includes:
a normalization processing unit configured to normalize the first floating-point number or the second floating-point number according to the computation mode to obtain a corresponding exponent and a corresponding mantissa when the first floating-point number or the second floating-point number is a non-normalized and non-zero floating-point number.

7. The multiplier of claim 1, wherein the mantissa processing unit includes a partial product computation unit and a partial product summation unit, wherein the partial product computation unit is configured to obtain an intermediate result according to the mantissa of the first floating-point number and the mantissa of the second floating-point number, and the partial product summation unit is configured to sum intermediate results to obtain a summation result and take the summation result as the mantissa after the multiplication computation.

8. The multiplier of claim 7, wherein the partial product computation unit includes a Booth encoding circuit, which is configured to add zeros and execute a Booth encoding processing to a high bit and a low bit of the mantissa of the first floating-point number or the second floating-point number to obtain the intermediate result.

9. The multiplier of claim 8, wherein the partial product summation unit may include an adder, which is configured to sum the intermediate results to obtain the summation result.

10. The multiplier of claim 8, wherein the partial product summation unit includes a Wallace tree and the adder, wherein the Wallace tree is configured to sum the intermediate results to obtain a second intermediate result, and the adder is configured to sum second intermediate results to obtain the summation result.

11. The multiplier of claim 9, wherein the adder includes at least one of adders including a full adder, a serial adder and a carry lookahead adder.

12. The multiplier of claim 10, wherein when a count of the intermediate results is less than M, zero values are added as the intermediate results to make the number of the intermediate results equal to M, wherein M is a presupposed positive integer.

13. The multiplier of claim 12, wherein each Wallace tree has M inputs and N outputs, and a count of the Wallace trees is no less than K, wherein N is a presupposed positive integer less than M, and K is a positive integer that is no less than a largest bit width of the intermediate results.

14. The multiplier of claim 13, wherein the partial product summation unit is configured to select one group or a plurality of groups of Wallace trees to sum the intermediate results, wherein each group of Wallace tree has X Wallace trees, and X is a bit number of the intermediate result, wherein Wallace trees in each group have successive carry relationships, but there is no carry relationship between Wallace trees from different groups.

15. The multiplier of claim 12, wherein the mantissa processing unit includes a control circuit, which is configured to call the mantissa processing unit multiple times according to the computation mode when the computation mode indicates that a mantissa bit width of at least one of the first floating-point number or the second floating-point number is larger than a data bit width that is processable at one time by the mantissa processing unit.

16. The multiplier of claim 15, wherein the partial product summation unit also includes a shifter; when the control circuit calls the mantissa processing unit multiple times according to the computation mode, the shifter is configured to shift an existing summation result in each calling and add the result to a summation result obtained in this calling to obtain a new summation result, and take a new summation result obtained in a last calling as the mantissa of the multiplication computation.

17. The multiplier of claim 16 further includes a normalization unit configured to:
execute floating-point number normalization processing to the mantissa and the exponent after the multiplication computation to obtain a normalized exponent result and a normalized mantissa result, take the normalized exponent result as the exponent after the multiplication computation, and take the normalized mantissa result as as the mantissa after the multiplication computation.

18. (canceled)

19. The multiplier of claim 1 further includes:
a mode selection unit configured to select the computation mode configured to indicate the data format of the first floating-point number and the data format of the second floating-point number from various computation modes supported by the multiplier.

20. A method configured to execute a multiplication computation of floating-point numbers through using a multiplier, wherein the floating-point numbers at least include an exponent and a mantissa, and the multiplier executes a multiplication computation based on a computation mode, and the method includes:
using an exponent processing unit of the multiplier to obtain an exponent after the multiplication computation according to the computation mode, an exponent of a first floating-point number and an exponent of a second floating-point number;
using a mantissa processing unit of the multiplier to obtain a mantissa after the multiplication computation according to the computation mode, a mantissa of the first floating-point number and a mantissa of the second floating-point number,
wherein the computation mode is configured to indicate a data format of the first floating-point number and a data format of the second floating-point number.

21. (canceled)

22. (canceled)
